(19) United States
(12) Patent Application Publication
(10) Pub. No.: US 2015/0115669 A1
(43) Pub. Date: Apr. 30, 2015

(54) CLIMATE CONTROLLED CHILD TRANSPORT

(71) Applicants: Danielle Kagan, Fort Myers, FL (US); Christopher Kagan, Fort Myers, FL (US)

(72) Inventors: Danielle Kagan, Fort Myers, FL (US); Christopher Kagan, Fort Myers, FL (US)

(21) Appl. No.: 14/067,550

(22) Filed: Oct. 30, 2013

(51) Int. Cl. B60N 2/56; B60N 2/28; B62B 7/00

(52) U.S. Cl. CPC B60N 2/5678; B62B 7/00; B60N 2/28; B60N 2/5607; B60N 2/5685
USPC 297/180.12; 297/180.1

(57) ABSTRACT

A climate controlled child transport. The climate controlled child transport includes a child transport, where the child transport is configured to transport a child. The climate controlled child transport also includes an environmental control, where the environmental control is configured to control an environmental condition within the child transport. The climate controlled child transport further includes an environmental monitor, where the environmental monitor is configured to monitor the environmental condition within the child transport.

### CROSS-REFERENCE TO RELATED APPLICATIONS

Not applicable.

### BACKGROUND OF THE INVENTION

Children, especially infants and babies, have very different metabolisms than adults. As a result, their body temperature is different and the environment that they are most comfortable can vary relative to the environment that is more comfortable to adults. In particular, children have a difficult time regulating their body temperature in more extreme environments or when their environments change relative to adults. For example, when a child is taken to a car or other vehicle that has been in a cold wintery environment the child's body temperature can drop more dramatically than the body temperature of an adult. Much of this is due to the child's smaller size, which allows the heat form the child's body to escape into the internal environment more quickly.

In addition, many vehicles include conveniences that help make environmental conditions more comfortable for adults, but that do not necessarily work for children. For example, many cars now include seats that have built in heaters allowing the occupant to warm more quickly. However, since children are seating in a child safety seat (or “car seat”) the in seat heater does nothing to help warm a child. I.e., the child safety seat acts as an insulator, preventing the child from benefiting from the in seat heater.

Accordingly, there is a need in the art for a child safety seat that can change one or more environmental conditions in the child's area. Further, there is a need in the art for the seat to include safety mechanisms which can ensure that the environment does not become dangerous for the child.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a climate controlled child transport. The climate controlled child transport includes a child transport, where the child transport is configured to transport a child. The climate controlled child transport also includes an environmental control, where the environmental control is configured to control an environmental condition within the child transport. The climate controlled child transport further includes an environmental monitor, where the environmental monitor is configured to monitor the environmental condition within the child transport.

Another example embodiment includes a climate controlled child transport. The climate controlled child transport includes a child transport, where the child transport is configured to transport a child. The climate controlled child transport also includes an environmental control, where the environmental control is configured to control an environmental condition within the child transport. The climate controlled child transport further includes an environmental monitor, where the environmental monitor is configured to monitor the environmental condition within the child transport and shut off the environmental control if the environmental condition passes a predetermined threshold. The climate controlled child transport additionally includes a power source electrically connected to the environmental control and the environmental monitor.

Another example embodiment includes a climate controlled child transport. The climate controlled child transport includes a child safety seat, where the child safety seat is configured to restrain a child in a vehicle. The climate controlled child transport also includes a heat pump, where the heat pump is configured to control the temperature of the child safety seat using a vapor-compression cycle. The climate controlled child transport further includes a transfer mechanism configured to move the temperature change from the heat pump to the child safety seat. The transfer mechanism includes a tube located within the child safety seat, a fluid within the tube, and a pump configured to move the fluid within the tube. The climate controlled child transport additionally includes an environmental monitor, where the environmental monitor is configured to monitor the temperature within the child safety seat and shut off the heat pump if the temperature passes a predetermined threshold. The climate controlled child transport moreover includes a power source configured to receive power from the vehicle and electrically connected to the heat pump and the environmental monitor.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of a climate controlled child transport;

FIG. 2 shows an example of a child safety seat;

FIG. 3 illustrates an example of an environmental control; and

FIG. 4 illustrates an example of a thermoelectric cooler.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

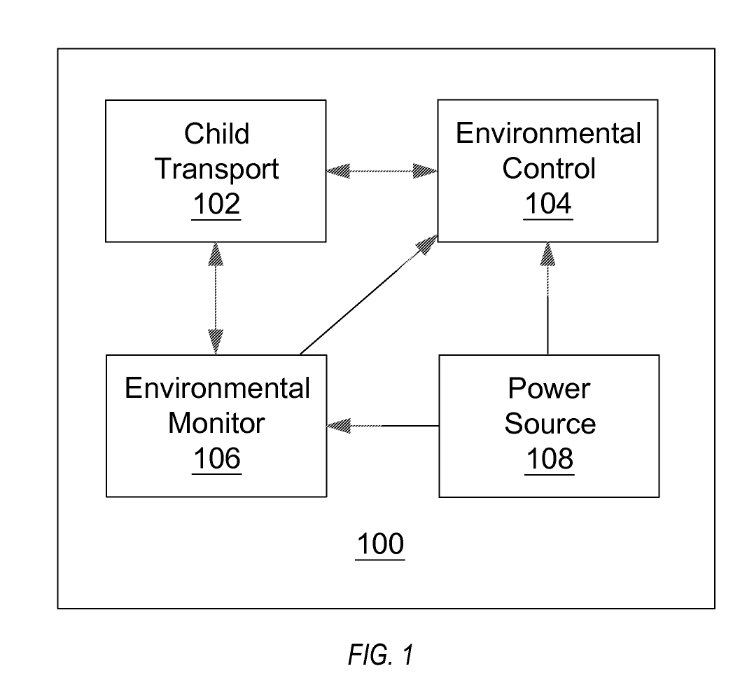

FIG. 1 illustrates an example of a climate controlled child transport 100. The climate controlled child transport 100 can allow a parent to control one or more environmental factors specifically for a child who requires a safety seat. In particular, a child may require different environmental controls than older children and adults. For example, children are more sensitive to extreme temperatures. Thus, the climate controlled child transport 100 can allow a parent to adjust environmental conditions for a child's needs.

FIG. 1 shows that the climate controlled child transport 100 can include a child transport 102. The child transport 102 can include any device for transporting or carrying a child or baby. For example, the child transport 100 can include a baby carriage, stroller, child safety seat, slings, backpacks, baskets, and bicycle carriers.

FIG. 1 also shows that the climate controlled child transport 102 100 can include an environmental control 104. The environmental control 104 can include any device configured to change the environment within or near the child transport 102. For example, the environmental control 104 can include a temperature control, humidity control or any other environmental control, as described below. The environmental control 104 or a portion thereof can be attached to the child transport 102. I.e., the environmental control 104 can be completely or partially integrated within the child transport 102.

For example, the environmental control 104 can include a resistance heater built into the child transport 102. I.e., the environmental control 104 can include a resistor that is configured to heat in the presence of an electrical current. Additionally or alternatively, the environmental control 104 can include an alternative heater, a thermoelectric cooler, a heat pump, a humidifier, a dehumidifier or any other mechanism for controlling the local environment.

FIG. 1 further shows that the climate controlled child transport 102 100 can include an environmental monitor 106. The environmental monitor 106 is configured to measure the actual environment in which the child is sitting. Little children, such as babies, may be unable or unwilling to tell his/her parents that the seat is uncomfortable or malfunctioning; therefore, the environmental monitor 106 must measure the actual environment rather than the intended environment. For example, if the environmental control 104 malfunctions and produces too much heat, the environmental monitor 106 can determine that the temperature has passed a safe threshold and set off an alarm that alarms the parents that the climate controlled child transport 102 100 should be checked to ensure child safety.

Additionally or alternatively, the environmental monitor 106 can be configured to shut down the environmental control 104 to prevent injury to the child if the environmental control 104 malfunctions. E.g., if the climate controlled child transport 102 100 begins to get too hot or too cold the environmental monitor 106 can be configured to shut off power to the environmental control to ensure that the baby does not suffer ill effects because of the malfunction.

FIG. 1 additionally shows that the climate controlled child transport 102 100 can include a power source 108. The power source 108 can be electrically connected to both the environmental control 104 and the environmental monitor 106 to allow the environmental control 104 and the environmental monitor 106 to operate properly. The power source 108 can include one or more batteries or can include a plug that allows the climate controlled child transport 102 100 to plug into an outlet, a vehicle power source (such as a cigarette lighter receptacle) or another power source (such as a USB plug).

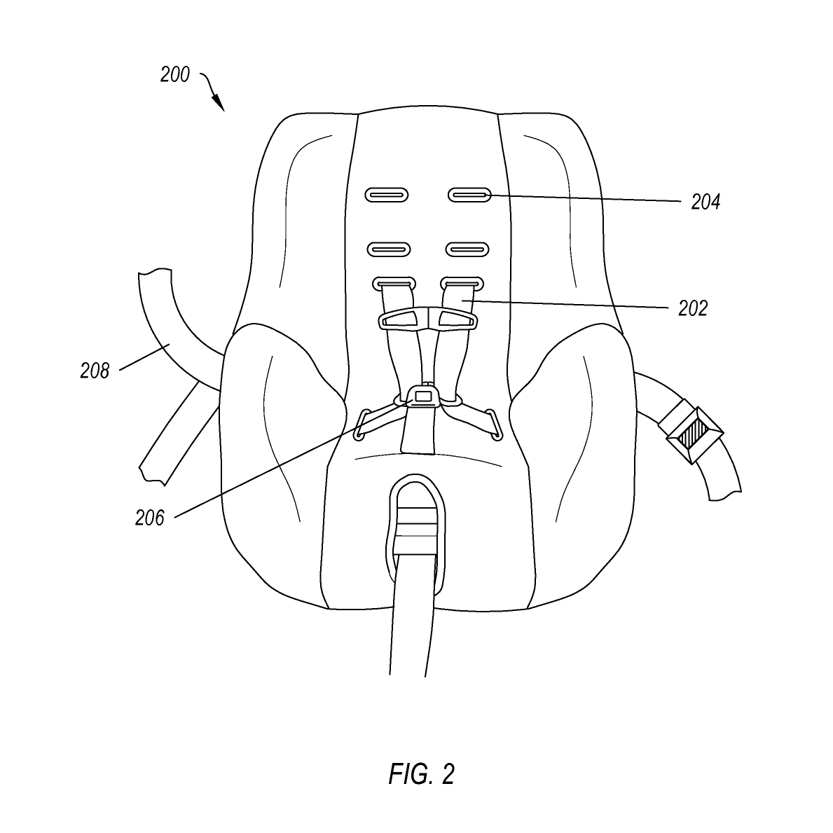

FIG. 2 shows an example of a child safety seat 200. A child safety seat helps restrain a child while in a vehicle. In particular, a child safety seat 200 is configured to restrain a child in such a way that would be inappropriate or uncomfortable for adults using adult restraints but that increases the safety of a child if an accident occurs. I.e., a child must be restrained in a vehicle different than an adult and thus requires a child safety seat 200 to adapt the adult restraints to restrain the child.

The child safety seat 200 can include any safety seat that is capable of restraining (or “buckling”) a child into a car or other vehicle. Child safety seats (sometimes referred to as an infant safety seat, a child restraint system, a restraint car seat, or ambiguously as car seats) are seats designed specifically to protect children from injury or death during collisions. Automobile manufacturers may integrate child safety seats 102 directly into their vehicle's design but more commonly, these seats are purchased and installed by consumers. Many regions require children defined by age, weight, and/or height to use a government-approved child safety seat 200 when riding in a vehicle. Child safety seats 102 provide passive restraints and must be properly used to be effective; however, many child safety restraints in countries such as Canada and the United States are not used properly.

Baby child safety seats 102 are legally required in many countries, including the United States, to safely transport children up to the age of 2 or more years in cars and other vehicles. Other child safety seats 102, also known as “booster seats,” are required up to somewhere around the age of 9 or a weight of 90 pounds.

Generally, countries that regulate passenger safety have child safety laws that require a child to be restrained appropriately depending on their age and weight. These regulations and standards are often minimums, and with each graduation to the next kind of safety seat, there is a step down in the amount of protection a child has in a collision. Some countries, such as Australia and the United States, forbid rear-facing child seats in a front seat that has an airbag. A rear-facing infant restraint put in the front seat of a vehicle places an infant's head close to the airbag, which can cause severe head injuries or death if the airbag deploys. Some modern cars include a switch, either manual or automatic, to disable the front passenger airbag for child-supporting seat use.

There are several types of child safety seats 102, which vary in the position of the child and size of the seat. The United Nations standard ECE R44/04[8] categorizes these into 4 groups: 0-3. Many child safety seats 102 combine the larger groups 1, 2 and 3. Some new car models include stock restraint seats by default.

Group 0-position: laying (in carrycots), rear facing (in infant carriers), no airbags (with the exception of curtain airbags); recommended weight: birth to 10 kg (22 lb.); and approximate age: birth to 12 month. Group 0 baby seats, or infant carriers, keep the baby locked up in a rear-facing position and are secured in place by a standard adult seat belt and/or an ISOFIX (standard attachment points to be manufactured into cars, enabling compliant child safety seats 102 to be quickly and safely secured) fitting. Group 0 carrycots hold the baby laying on its back. Carrycots are secured by both seat belts in the rear seat of the car. Both types have handles to allow them to be easily moved into and out of the car.

Fastened carrycots—‘Carrycots’ are a restraint system intended to accommodate and restrain the child in a supine or prone position with the child's spine perpendicular to the median longitudinal plane of the vehicle. Carrycots are designed to distribute the restraining forces over the child's head and body, excluding its limbs, in the event of a big crash. It must be put on the rear seat of the car. Some models can be changed to face forward after the baby has reached the weight limit which is normally about 15-20 kilograms. Carrycots generally include a stomach belt and a connection to the (three points) safety belt.

Infant carriers—‘Infant carrier’ means a restraint system intended to accommodate the child in a rearward-facing semi-recumbent position. This design distributes the restraining forces over the child's head and body, excluding its limbs, in the event of the frontal collision. For young infants, the seat used is an infant carrier with typical weight recommendations of 5-20 lb. Most infant seats made in the US can now be used up to at least 22 lb. and 29 inches, with some going up to 35 lbs. In the past, most infant seats in the US went to 20 lb. and 26 inches. Infant carriers are often also called “Bucket Seats” as they resemble a bucket with a handle. Some (but not all) seats can be used with the base secured, or with the carrier strapped in alone. Some seats do not have bases. Infant carriers are mounted rear-facing and are designed to “cocoon” against the back of the vehicle seat in the event of a collision, with the impact being absorbed in the outer shell of the restraint. Rear-facing seats are deemed the safest, and in the US children must remain in this position until at they are least 1 year of age and at least 20 pounds.

Group O+-position: sitting, rear facing, no airbag (with the exception of curtain airbags); recommended weight: birth (2-3 kg) to 13 kg (29 lb); and approximate age: birth to 15 months. Group O+ child safety seats 102 commonly have a chassis permanently fixed into the car by an adult seat belt and can be placed into a pushchair using the integral handle if it is the specific model. Rear-facing child seats are inherently safer than forward-facing child seats because they provide more support for the child's head in the event of a sudden deceleration. Although some parents are eager to switch to a forward-facing child seat because it seems more “grown up,” various countries and child safety seat 200 manufacturers recommend that children continue to use a rear-facing child seat for as long as physically possible.

Convertible seats—convertible seats can be used throughout many stages. Many convertible seats will transition from a rear-facing seat, to a forward-facing seat, and some then can be used as a booster seat. Many convertible seats allow for 5-35 lb. rear-facing, allowing children to be in the safer rear-facing position up to a weight of 35 pounds. Convertible safety seats can be installed as either rear-facing or forward-facing. There is a large selection available to choose from and weight limits, height limits, and extra features vary from seat to seat and by manufacturer. Seats with a 5-point harness are considered safer than those with an overhead shield. Convertibles are not considered the best choice for a newborn because the bottom harness slots are often above the shoulders of most newborns. A seat with low bottom harness slots can be used if it is desired to use a convertible from birth. Rear-facing weight limits range from 20 to 35 lb. (9.1 to 16 kg) depending on the manufacturer and country of origin. Forward-facing limits range from 17.6 to 65 lb. (8.0 to 29 kg) depending on the seat model and the manufacturer and country of origin. Most convertible seats in the U.S. have at least a 30 lb. rear-facing weight limit, most now to go to 35 lbs., some 40 lbs., and a few 45. The American Academy of Pediatrics (AAP) recommends that children remain rear-facing until they outgrow their convertible seat, regardless of how old they are. Children can remain in a rear-facing seat until they have either outgrown the weight limit for their seat, or the top of their head is within an inch of the top of the shell of the child safety seat 200.

Group 1-position: sitting, recommended rear facing but forward facing is legal, no airbag (with the exception of curtain airbags); recommended weight: 9 to 18 kg (20 to 40 lb.); and approximate age: 9 months to 4 years (although older children can fit too sometimes). Group 1 child safety seats 102 include a permanent fixture in the car using an adult seat belt to hold it in place and a five-point baby harness to hold the infant. It is recommended that children sit rear-facing for as long as possible. In Scandinavian countries, for example, children sit rear-facing until around 4-years-old. Rear-facing child safety seats 102 are significantly safer in frontal collisions, which are the most likely to cause severe injury and death.

Group 2-position: sitting, forward-facing or rear-facing (make sure the seat is certified for up to 25 kg); recommended weight: 15 kg to 25 kg (33 lb. to 55 lb.); and approximate age: 4 to 6 years (although older children can sometimes fit). A larger seat than the Group 1 design. These seats use an adult seat belt to hold the child in place.

Group 3—Position: Sitting, forward-facing; recommended weight: 22 kg to 36 kg (48 lb. to 76 lb.); and approximate age: 4 to 10, and above if the child is not 36 kg yet. Also known as booster seats, these position the child so that the adult seat belt is held in the correct position for safety and comfort.

Booster seats—Booster seats are recommended for children until they are big enough to properly use a seat belt. Seat belts are engineered for adults, and are thus too big for small children. In the United States, for children under the age of 4 and/or under 40 lb., a seat with a 5-point harness is suggested instead of a booster seat. Booster seats lift the child and allow the seat belt to sit firmly across the collar bone and chest, with the lap portion fitted to the hips. If the seat belt is not across the collar bone and the hips, it will ride across the neck and the stomach and cause internal injuries in the event of a collision. There are two main types of boosters: high back (some of which have energy absorbing foam) and no back. A new generation of booster seats comes with rigid ISOFIX connectors that secure to the vehicle's ISOFIX anchors, improving the seat's stability in the event of a collision.

FIG. 2 shows that the child safety seat 200 can include a harness 202. The harness 202 is configured to restrain the child during a sudden deceleration and to hold the child in the proper position prior to a collision. For example, the harness 202 can include a five point harness system which means that the child is restrained at the shoulders, groin and hips. I.e., the force is distributed throughout the trunk of the child, reducing the impact force at any one point.

FIG. 2 also shows that the child safety seat 200 can include one or more adjustments 204. The adjustments 204 allow a parent to adjust the child safety seat 200 to a child's size. For example, the shoulder straps can be lowered or raised and/or the position of the groin strap can be moved forward or backward to adjust to the child's height. Additionally or alternatively, the portion of the harness 202 which can be used to restrain the child can be adjusted to ensure that the harness 202 remains snug when the child is restrained.

FIG. 2 further shows that the child safety seat 200 can include one or more latches 206. The latches 206 allow a parent to restrain or free a child from the child safety seat 200. For example, there can be a groin latch and a chest clip which ensures that the harness remains in place relative to the child so that force is properly distributed.

FIG. 2 additionally shows that the child safety seat 200 can include a belt path 208. The belt path 208 allows an adult restraint to pass through the child safety seat 200, securing the child safety seat 200 to the vehicle. In particular, the belt path 208 attaches the child safety seat 200 to vehicle so that even in the event of an accident the position of the child safety seat 200 remains fixed relative to the vehicle.

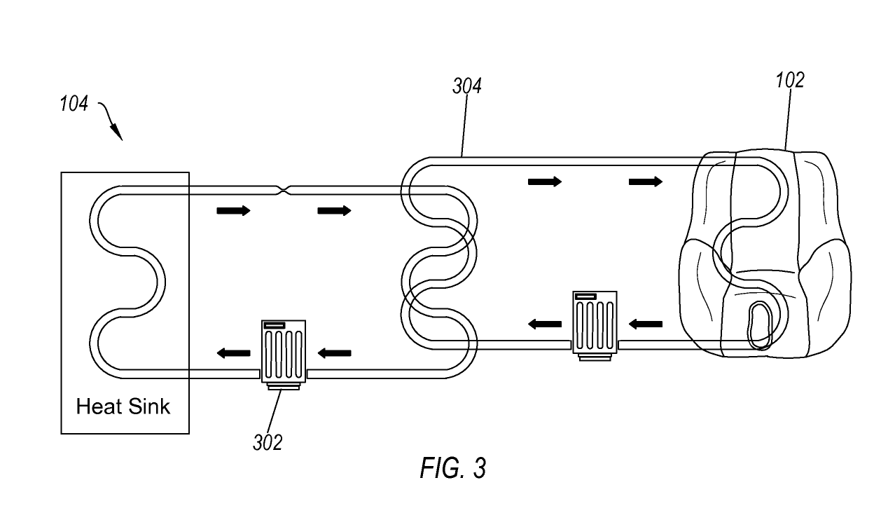

FIG. 3 illustrates an example of an environmental control 104. An environmental control can include a device configured to change one or more environmental conditions in the local area. For example, the environmental control 104 can be a heater, cooler, a humidifier, a dehumidifier or can be used to change any other desired environmental condition.

FIG. 3 shows that the environmental control 104 can include a heat pump 302. A heat pump 302 is a machine or device that moves heat from one location (the ‘source’) at a lower temperature to another location (the ‘sink’ or ‘heat sink’) at a higher temperature using mechanical work or a high-temperature heat source. Thus a heat pump 302 may be thought of as a “heater” if the objective is to warm the heat sink (as when warming the inside of a home on a cold day), or a “refrigerator” if the objective is to cool the heat source (as in the normal operation of a freezer). In either case, the operating principles are identical; heat is moved from a cold place to a warm place. The source and the heat sink can include either air within the vehicle or air external to the vehicle. For example, in the case of cooling, the source can include the child safety seat and the heat sink can include the interior of the vehicle or device external to the vehicle.

For example, the heat pump 302 can include a vapor-compression cycle. In this cycle, a circulating refrigerant such as Freon enters the compressor as a vapor. The vapor is compressed at constant entropy and exits the compressor superheated (because of the compression rather than because of heating). The superheated vapor travels through the condenser which first cools and removes the superheat and then condenses the vapor into a liquid by removing additional heat at constant pressure and temperature. The liquid refrigerant goes through the expansion valve (also called a throttle valve) where its pressure abruptly decreases, causing flash evaporation and auto-refrigeration of, typically, less than half of the liquid. That results in a mixture of liquid and vapor at a lower temperature and pressure. The cold liquid-vapor mixture then travels through the evaporator coil or tubes and is completely vaporized by cooling the warm air (from the space being refrigerated) being blown by a fan across the evaporator coil or tubes. The resulting refrigerant vapor returns to the compressor inlet to complete the thermodynamic cycle. The above discussion is based on the ideal vapor-compression refrigeration cycle, and does not take into account real-world effects like frictional pressure drop in the system, slight thermodynamic irreversibility during the compression of the refrigerant vapor, or non-ideal gas behavior (if any) which lower the efficiency of the heat pump 302.

The heat pump 302 can include a separate unit that moves with the car seat or can be built into the vehicle. For example, the heat pump 302 can include a mechanism which is placed within the vehicle or built into the child safety seat. Additionally or alternatively, the heat pump 302 can include a portion of the vehicles environmental controls, such as an air conditioner or heater, which can be connected to a climate controlled child transport.

FIG. 3 also shows that the environmental control 104 can include a transfer mechanism 304. The transfer mechanism 304 can be configured to move the environmental change from the heat pump 302 to a child transport 102. For example, the transfer mechanism 304 can include a pump which moves a fluid through a tube. The tube can allow the fluid to circulate through the child transport 102 to a coolant treated by the heat pump 302 where it is again heated/cooled. This cycle can be repeated constantly, adjusting the temperature of the child transport 102. Additionally or alternatively, the transfer mechanism 304 can include a cooling area through which a fluid passes to cool/heat. For example, the transfer mechanism 304 can include a fluid which passes through a cooled area to the child safety seat and back to the cooled area without directly connecting to the heat pump 302.

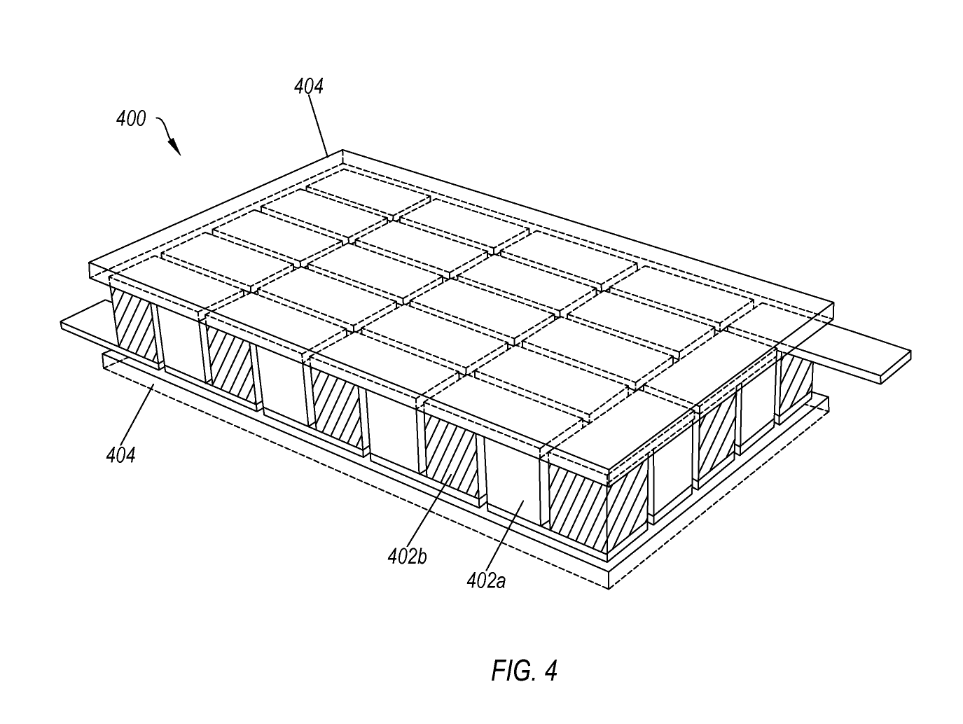

FIG. 4 illustrates an example of a thermoelectric cooler (TEC) 400. The TEC 400 can be used as an environmental control. In particular, the TEC 400 can be used to directly heat or cool a child safety seat. I.e., the environmental control 104 of FIG. 3 heats/cools a substance which then is used to cool a child safety seat. In contrast, the TEC 400 can directly heats/cool the child safety seat without an intermediate used to transfer the heat.

A TEC 400 is a solid-state active heat pump which transfers heat from one side of the device to the other side against the temperature gradient (from cold to hot), with consumption of electrical energy. A TEC 400 uses the Peltier effect to create a heat flux between the junction of two different types of materials. I.e., a TEC 400 is a heat pump: when direct current runs through it, heat is moved from one side to the other. The “hot” side is attached to a heat sink so that it remains at or near ambient temperature, while the cool side goes below room temperature. In some applications, multiple coolers can be cascaded together for lower temperature. One of skill in the art will appreciate that the TEC 400 can be used to produce both heat and cold in the child safety seat depending on the direction of the current.

A TEC 400 offers the following benefits relative to a heat pump: electrical power can be easily accessed in most vehicles; no moving parts so maintenance is required less frequently; no chlorofluorocarbons; temperature control to within fractions of a degree can be maintained; flexible shape (form factor); in particular, they can have a very small size; can be used in environments that are smaller or more severe than conventional refrigeration; has a long life, with mean time between failures exceeding 100,000 hours; and is controllable via changing the input voltage/current. A TEC 400 has the following disadvantages relative to a heat pump: only a limited amount of heat flux is able to be dissipated; relegated to applications with low heat flux; and not as efficient, in terms of coefficient of performance, as vapor-compression systems.

FIG. 4 shows that the TEC 400 can include two unique semi-conductors 402 (including 402a and 402b collectively), one n-type (402a) and one p-type (402b), are used because they need to have different electron densities. The semi-conductors 402 are placed thermally in parallel to each other and electrically in series and then joined with a thermally conducting plate 404 on each side. When a voltage is applied to the free ends of the two semiconductors 402 there is a flow of direct current across the junction of the semi-conductors causing a temperature difference. The side with the cooling plate absorbs heat which is then moved to the other side end of the device where the heat sink is located. TECs 400 are typically connected side by side and sandwiched between two ceramic plates. The cooling ability of the total unit is then proportional to the number of TECs 400.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A climate controlled child transport, the climate controlled child transport comprising:
a child transport, wherein the child transport is configured to transport a child;
an environmental control, wherein the environmental control is configured to control an environmental condition within the child transport; and
an environmental monitor, wherein the environmental monitor is configured to monitor the environmental condition within the child transport.

2. The climate controlled child transport of claim 1, wherein the child transport includes a stroller.

3. The climate controlled child transport of claim 1, wherein the environmental control includes a heater.

4. The climate controlled child transport of claim 3, wherein the heater includes a resistance heater.

5. The climate controlled child transport of claim 1, wherein the environmental control includes a heat pump.

6. The climate controlled child transport of claim 5 further comprising:
a transfer mechanism configured to move the environmental change from the heat pump to the child transport.

7. The climate controlled child transport of claim 6, wherein the transfer mechanism includes:
a tube located within the child transport;
a fluid within the tube; and
a pump configured to move the fluid within the tube.

8. The climate controlled child transport of claim 5, wherein the heat pump includes a vapor-compression cycle.

9. The climate controlled child transport of claim 1, wherein the environmental control includes a cooler.

10. The climate controlled child transport of claim 9, wherein the cooler includes a thermoelectric cooler.

11. The climate controlled child transport of claim 1, wherein the environmental monitor is configured to shut off the environmental control if the environmental condition passes a predetermined threshold in the child transport.

12. A climate controlled child transport, the climate controlled child transport comprising:
a child transport, wherein the child transport is configured to transport a child;
an environmental control, wherein the environmental control is configured to control an environmental condition within the child transport;
an environmental monitor, wherein the environmental monitor is configured to monitor the environmental condition within the child transport and shut off the environmental control if the environmental condition passes a predetermined threshold; and
a power source electrically connected to the environmental control and the environmental monitor.

13. The climate controlled child transport of claim 12, wherein the power source includes a battery.

14. The climate controlled child transport of claim 12, wherein the power source includes a plug configured to electrically connect the child transport to the vehicle.

15. The climate controlled child transport of claim 12, wherein the plug includes a plug configured to connect to a cigarette lighter receptacle.

16. The climate controlled child transport of claim 12, wherein the environmental monitor is configured to produce an alarm if the environmental condition passes the predetermined threshold.

17. A climate controlled child transport, the climate controlled child transport comprising:
a child safety seat, wherein the child safety seat is configured to restrain a child in a vehicle;
a heat pump, wherein the heat pump is configured to control the temperature of the child safety seat using a vapor-compression cycle; and
a transfer mechanism:
configured to move the temperature change from the heat pump to the child safety seat; and
includes:
a tube located within the child safety seat;
a fluid within the tube; and
a pump configured to move the fluid within the tube
an environmental monitor, wherein the environmental monitor is configured to monitor the temperature within the child safety seat and shut off the heat pump if the temperature passes a predetermined threshold; and
a power source:
configured to receive power from the vehicle; and
electrically connected to the heat pump and the environmental monitor.

18. The climate controlled child transport of claim 17, wherein the heat pump includes the vehicle's air conditioner.

19. The climate controlled child transport of claim 17, wherein the child safety seat includes an infant carrier.

20. The climate controlled child transport of claim 17, wherein the child safety seat includes a booster seat.
